(19) United States
(12) Patent Application Publication
(10) Pub. No.: US 2007/0079664 A1
(43) Pub. Date: Apr. 12, 2007

(54) Cam actuated motorcycle clutch control

(76) Inventor: Karel Hajek, Fresh Meadows, NY (US)

Correspondence Address: Karel Hajek, 75 59 196th St., Fresh Meadowns, NY, 11366, US

(21) Appl. No.: 11/449,379

(22) Filed: Dec. 5, 2006

Related U.S. Application Data
(60) Provisional application No. 60/701,289, filed on Jul. 21, 2005.

(51) Int. Cl. G05G 1/10

(52) U.S. Cl. 74/543

(57) ABSTRACT

The Cam acutuated motorcycle cluth control is a new type of clutch for use in off road motorcycles. It significantly improves the rider's ability to adjust free play, and change the clutch lever in case it breaks. It also provides a much longer life span, as its material is extremely resistant. This clutch provides a more reliable and smoother operation. Its ingenious design allows the invention to be used in virtually any motorcycle handle bar, and allows the user to adjust cable tension on the fly, meaning one does not have to stop riding in order to adjust free play.

Product Description

This Cam actuated motorcycle clutch control is geared towards replacing all current designs for the clutch mechanism that exists in motorcycles today. It improves significantly on most common problems that takes place today with clutches and brings on additional benefits as well.

The Housing, housing cover and lever are all made out of machined 7075 aluminum. When the invention is entirely assembled, it takes on a L shape, in order to best be used on handlebars. The product has a cable adjuster on the left side, this way it can be easily accessed by the rider while riding. The clutch cable comes from under the handlebar and enters the device in its right side, and so the clutch cable ends up being between the rider and the handlebars. On the top there is the lever which is secured by one screw, thus allowing for a quick lever change if needed. The housing is completely sealed; this prevents any dirt or debris from entering the link mechanism. This is done by machining the housing cover so that it fits snuggly into the housing.

Alternate Description

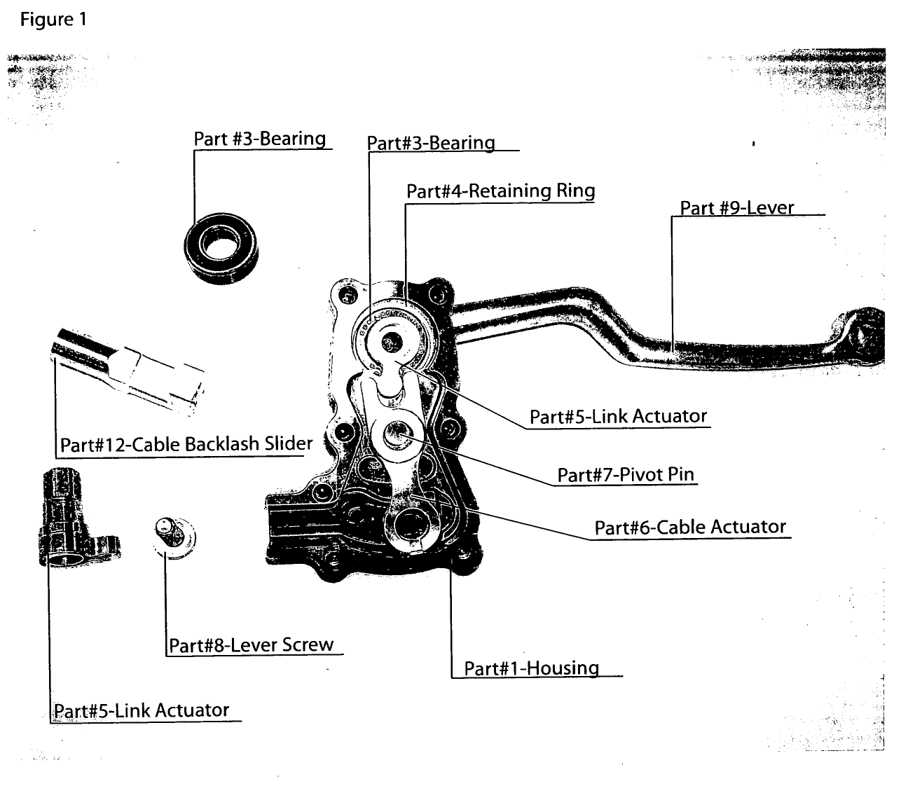

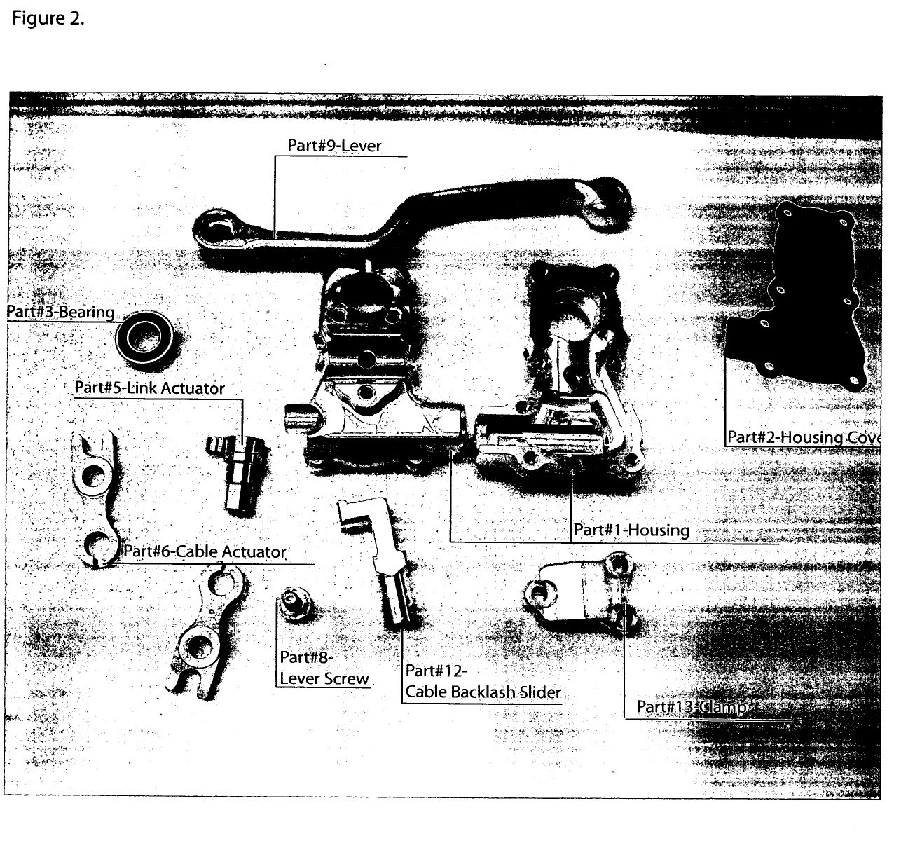

FIG. 1 is a perspective view taken from the top of the clutch control constructed in accordance with the invention. Part #1 is the housing which is constructed of 7075 aluminum. Part #2 is the ball bearing where the lever actuator sits. The ball bearing will remain secured in place by use of a retaining ring. Part #5 is the link actuator which is made of 4340 steel and is heat treated to Rockwell 55. Link actuator will remain in place by use of the lever screw as indicated in drawing. Part #6 is the cable actuator made of 4340 steel heat treated to Rockwell 55. Cable actuator remains in place by use of Part #7 a pivot pin. This allows for only the opposite end of the cable actuator to move in opposite direction of the link actuator. Part #12 is the cable backlash slider to control back lash or cable “freeplay” for the clutch cable coming in from the engine/transmission. Part #10 is the cable backlash adjuster by screw, so that one may adjust “freeplay” or tension by the rotation of the screw. Part #8 is the screw used to hold down the link actuator in its place. The screw is designed to also lock down the user's clutch lever on the other side. With the use of this screw the clutch lever will be either installed or removed by simply unscrewing it.

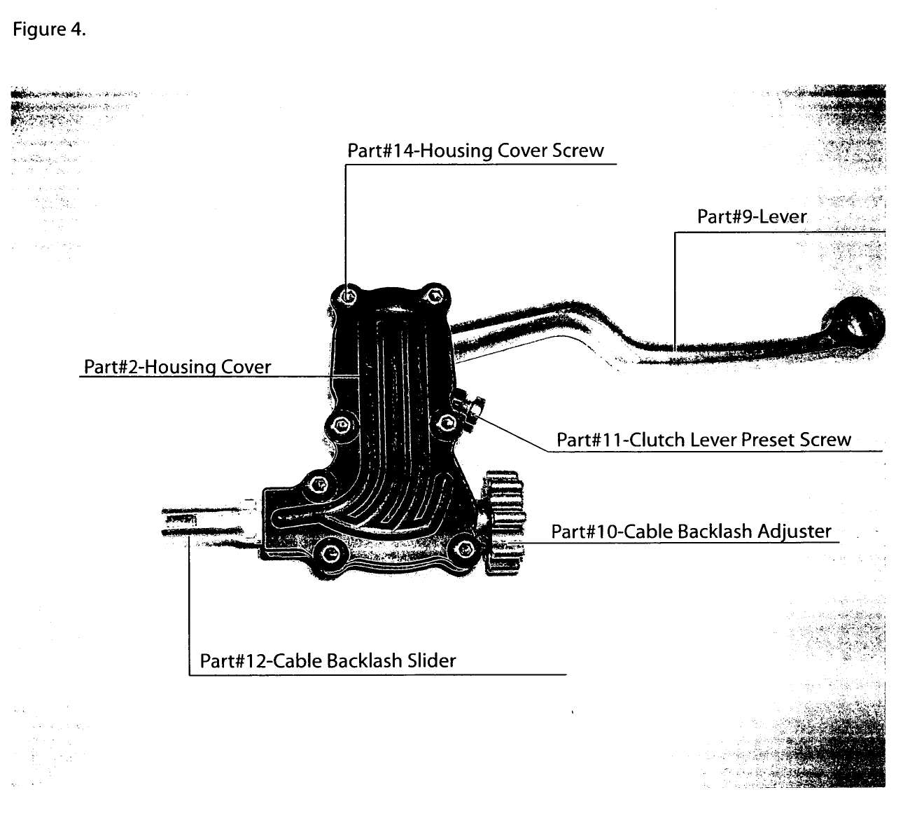

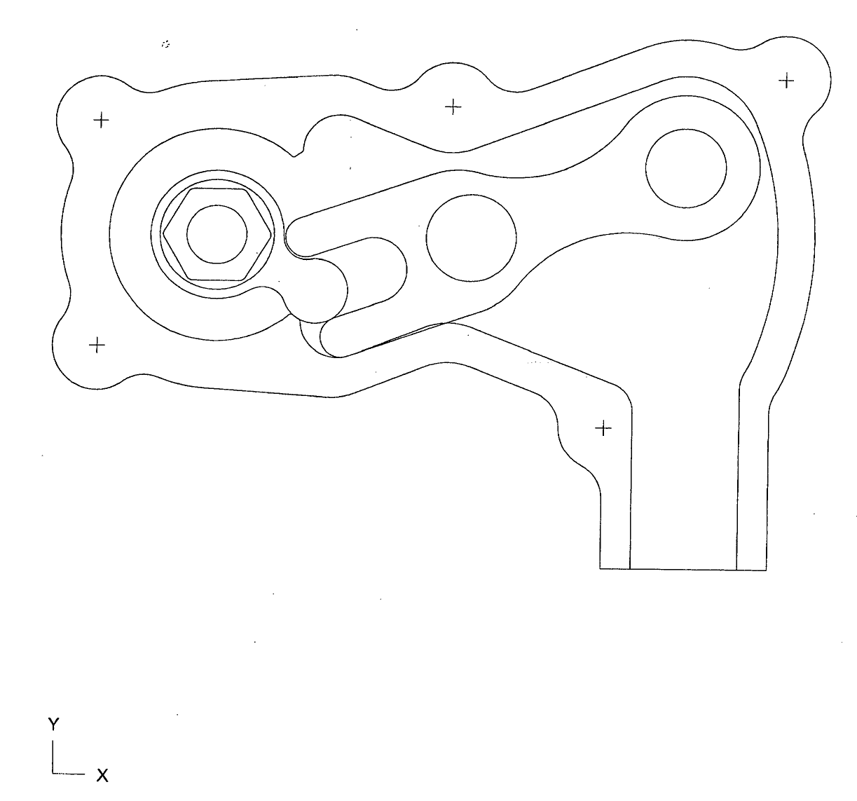

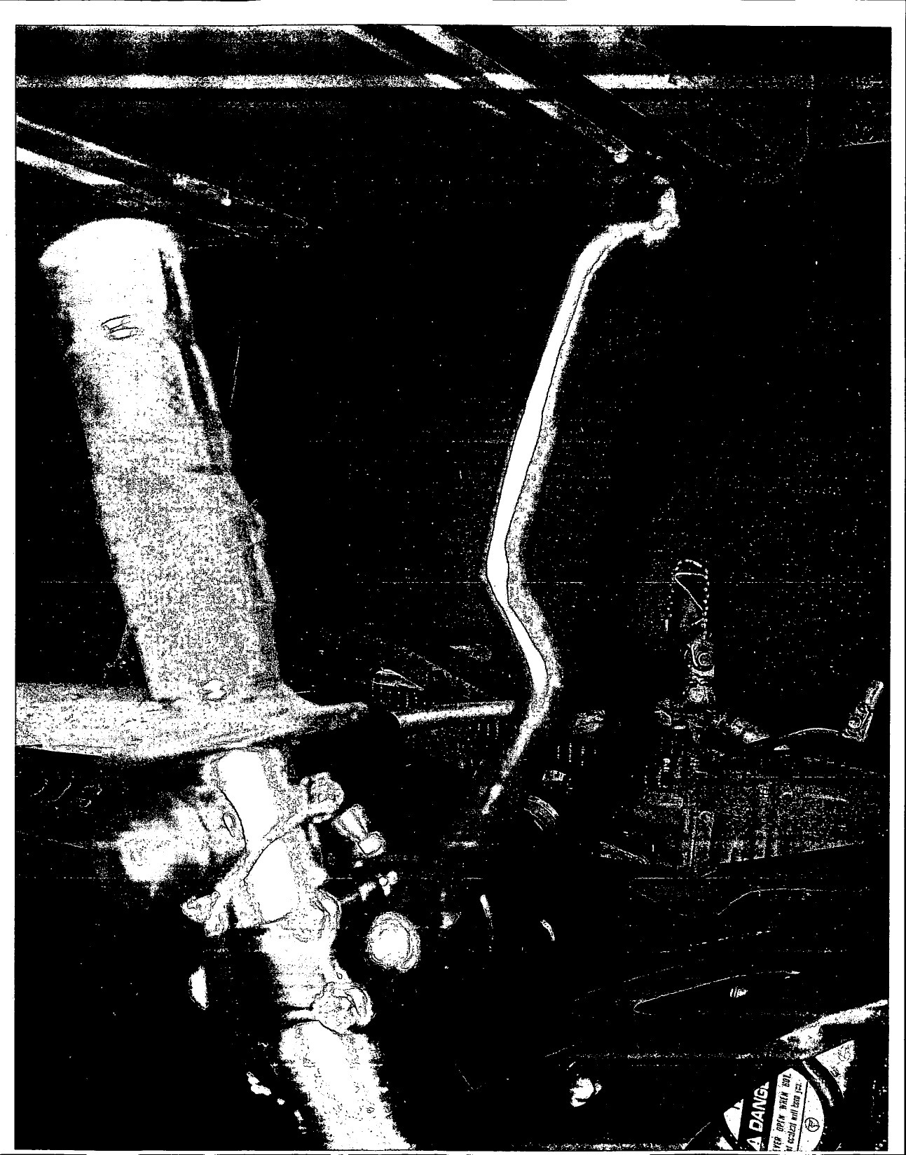

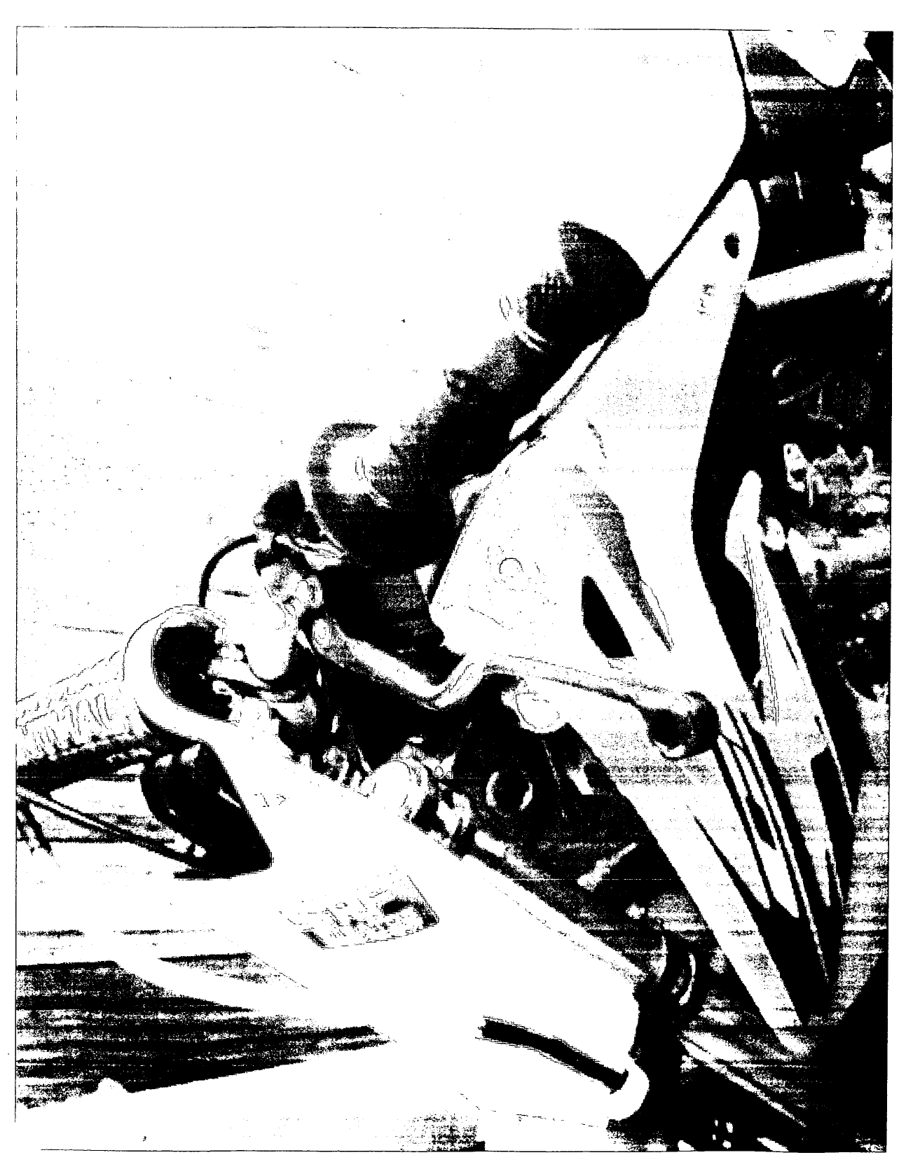

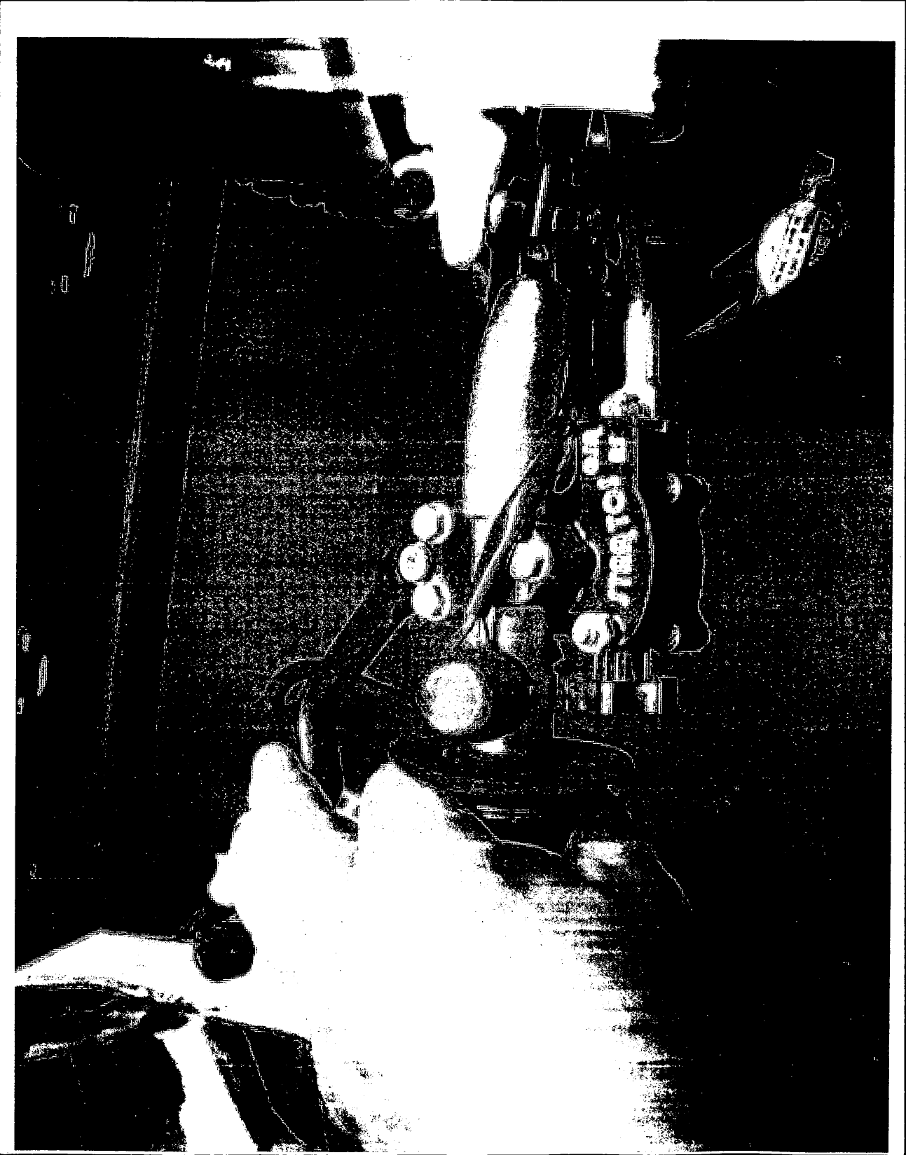

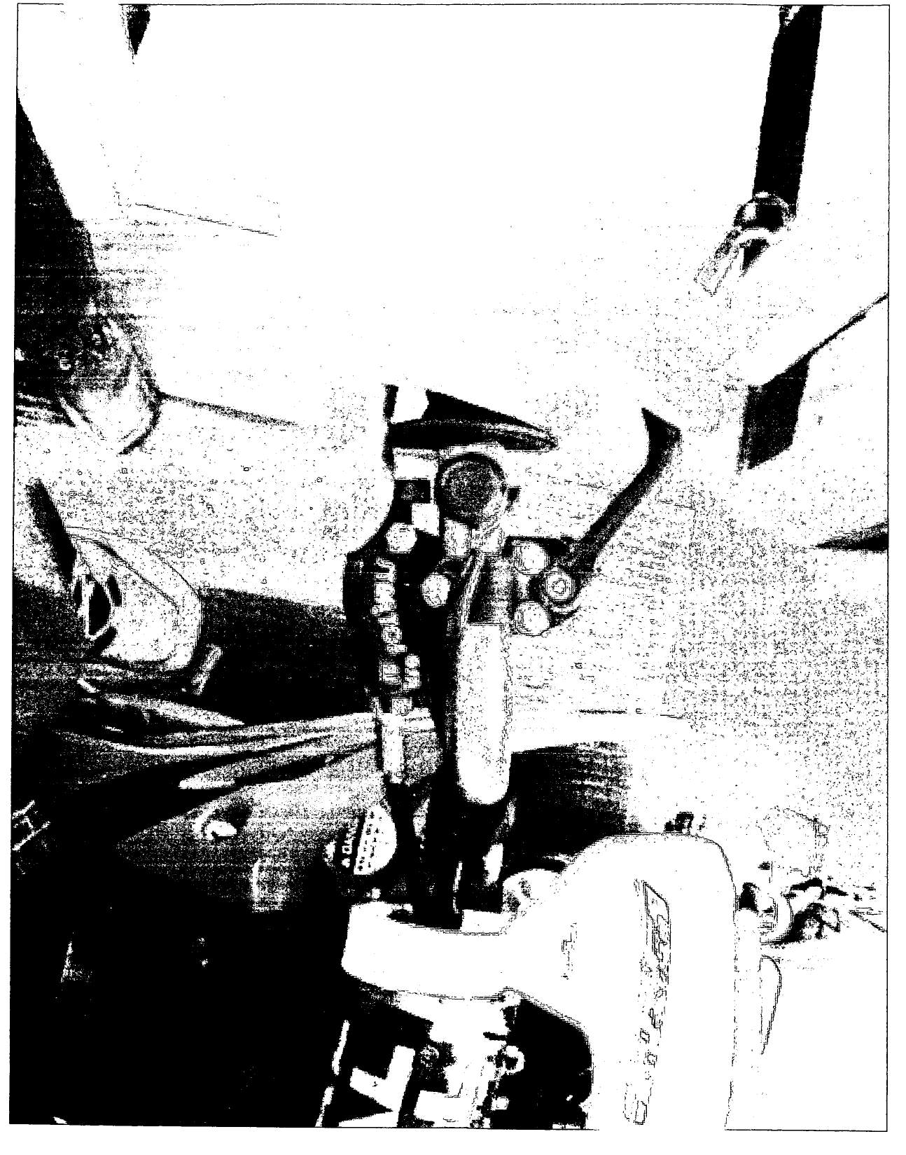

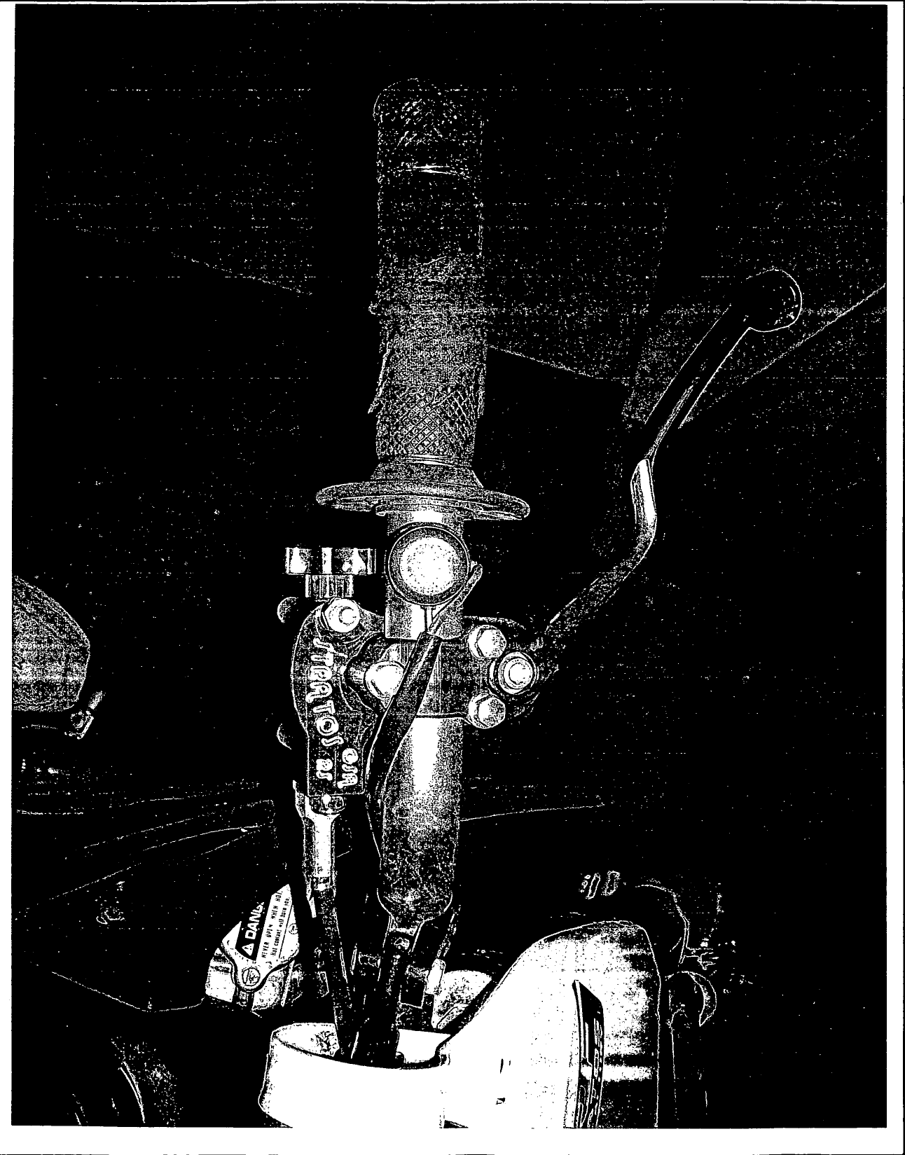

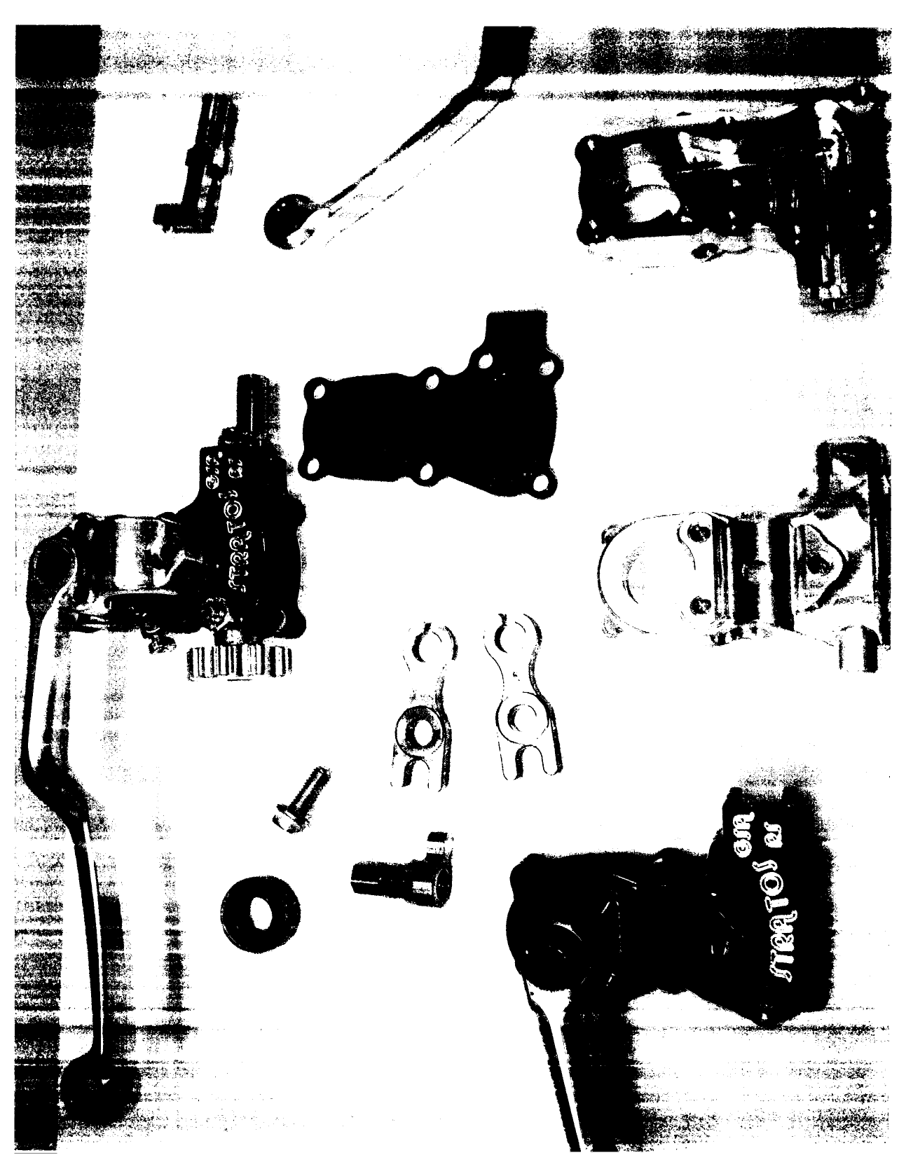

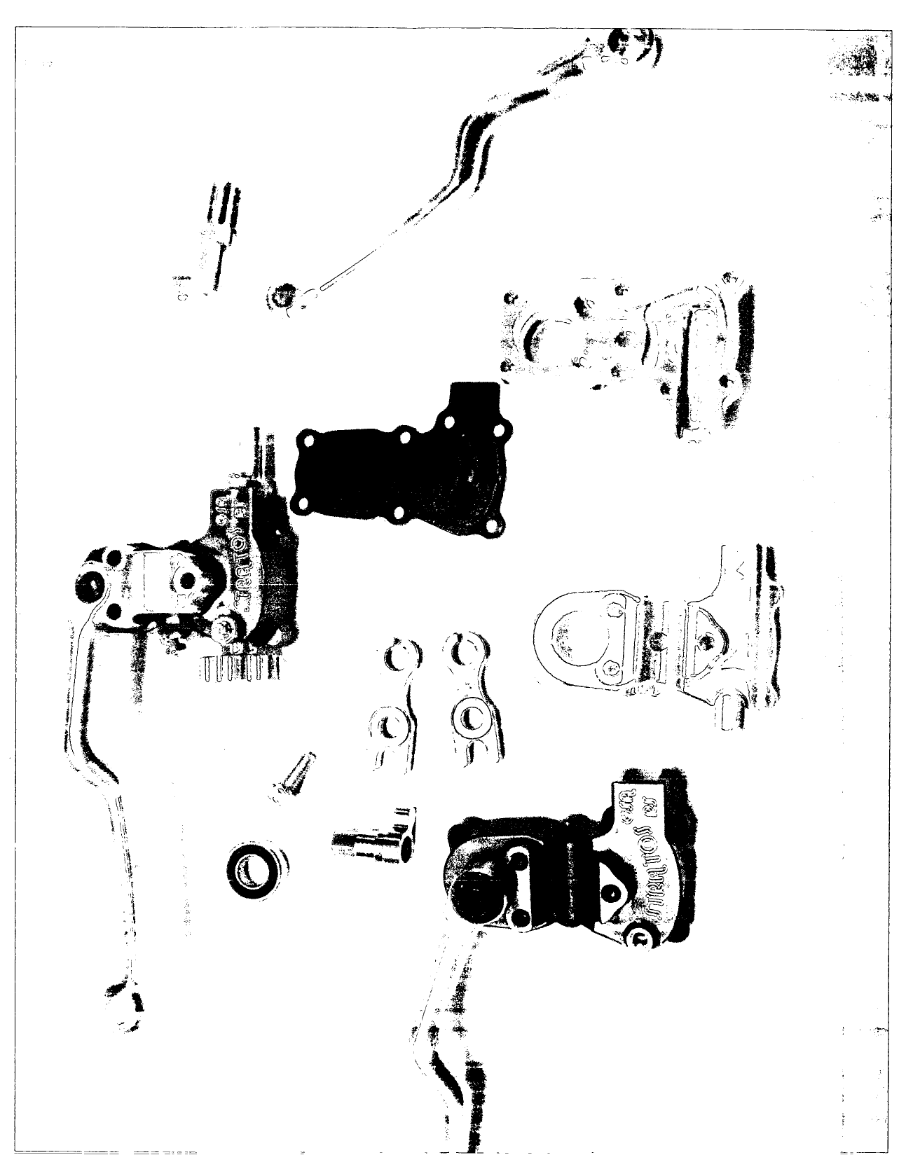

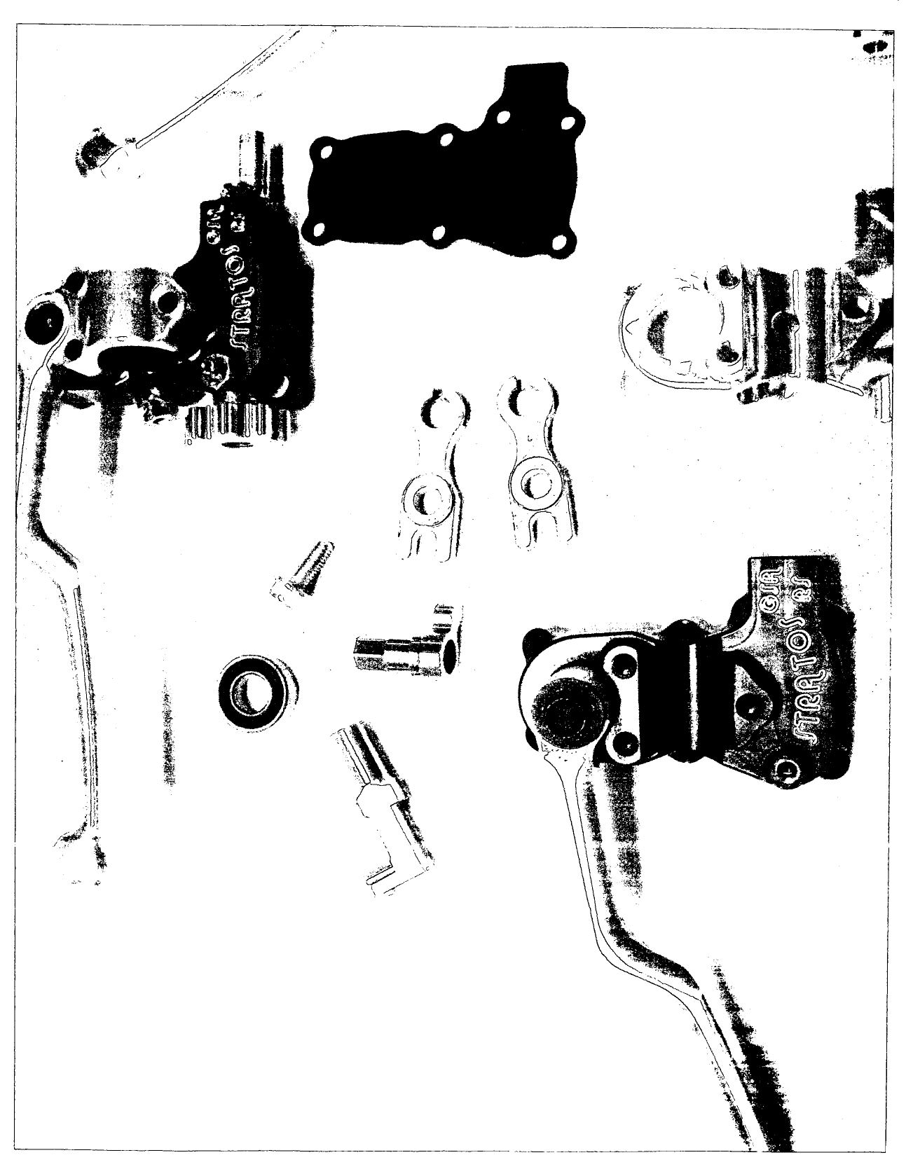

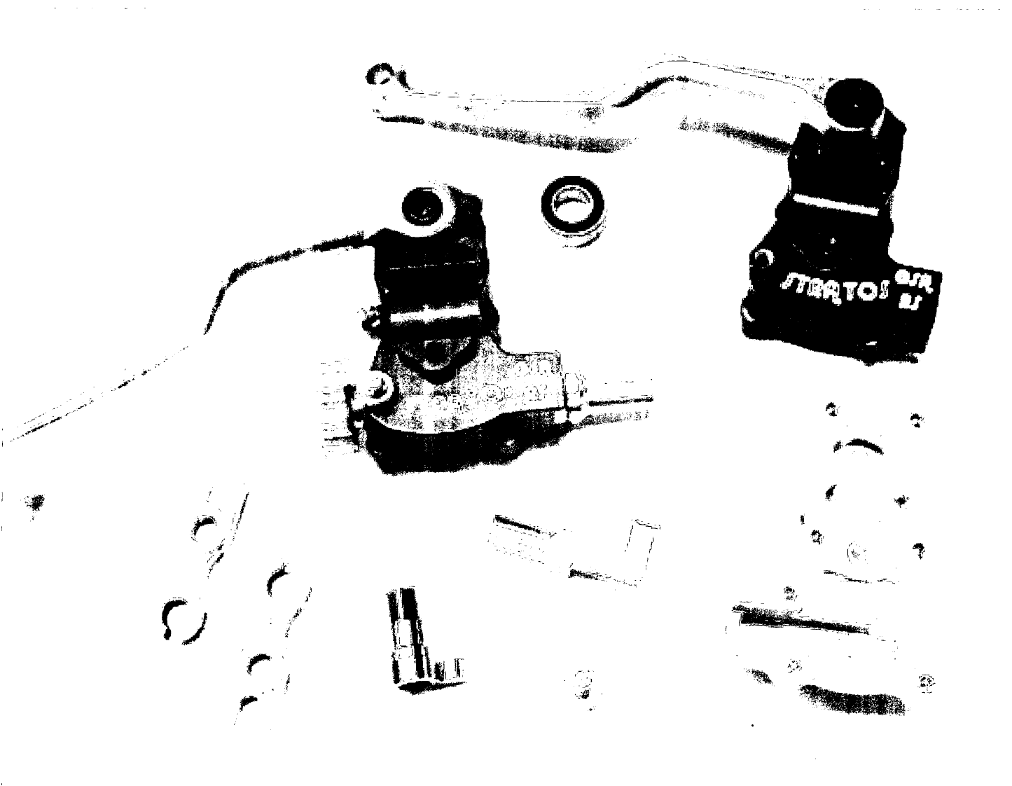

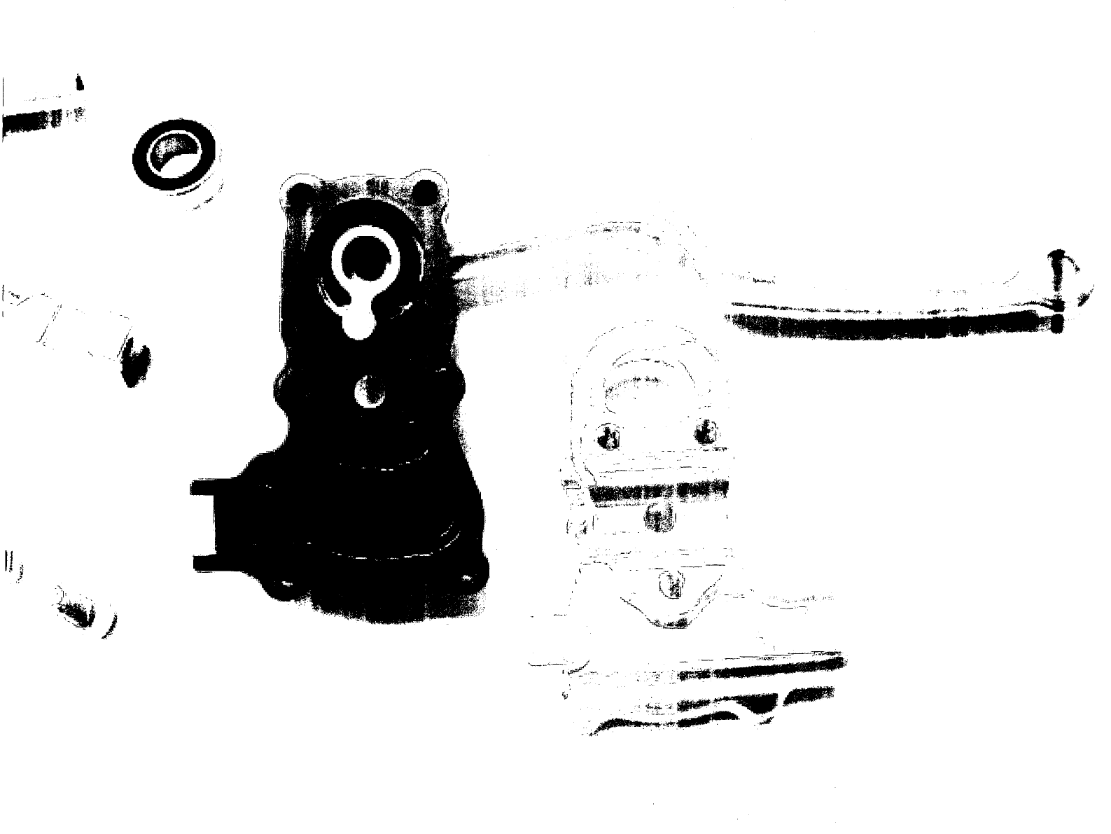

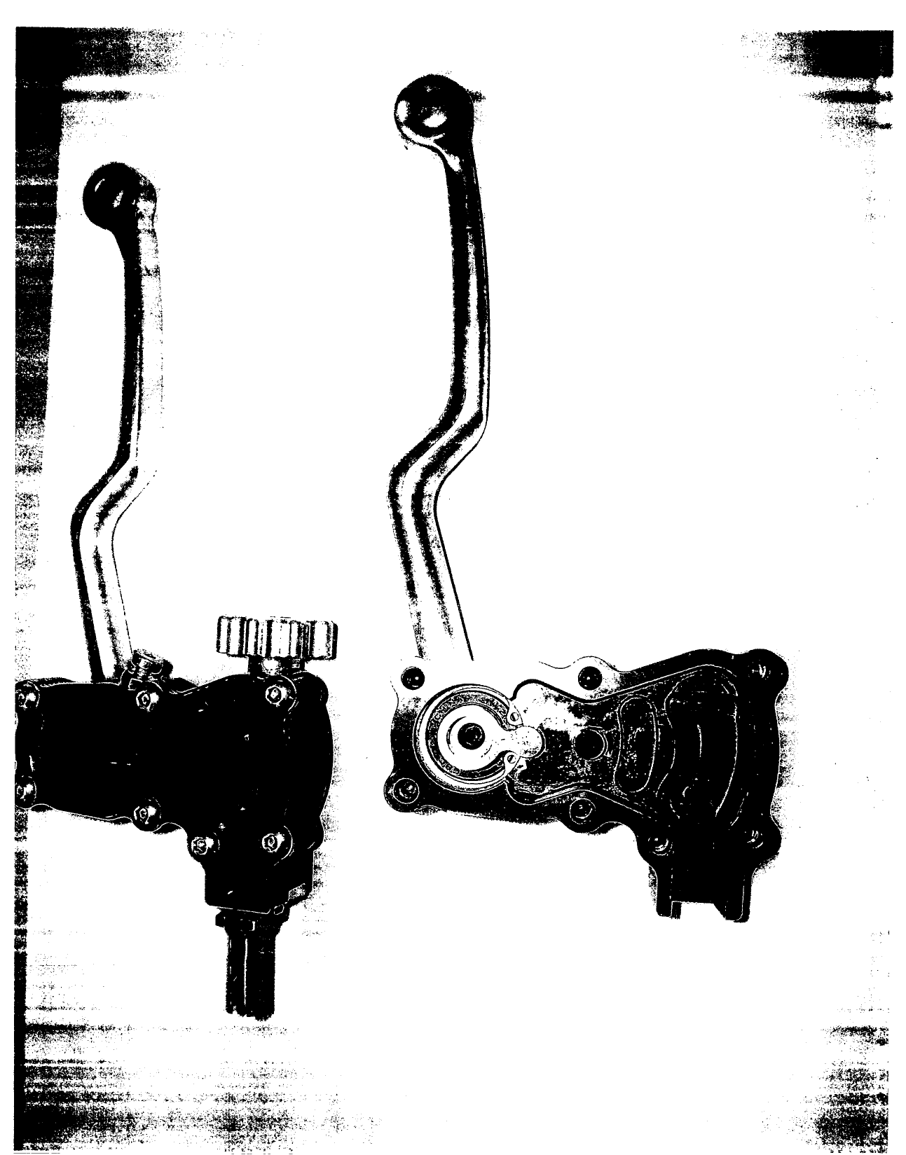

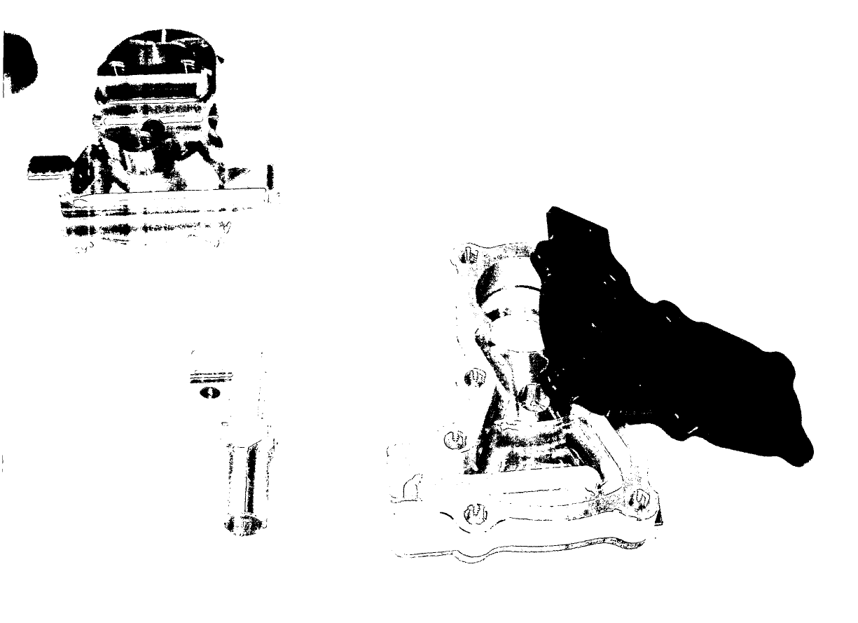

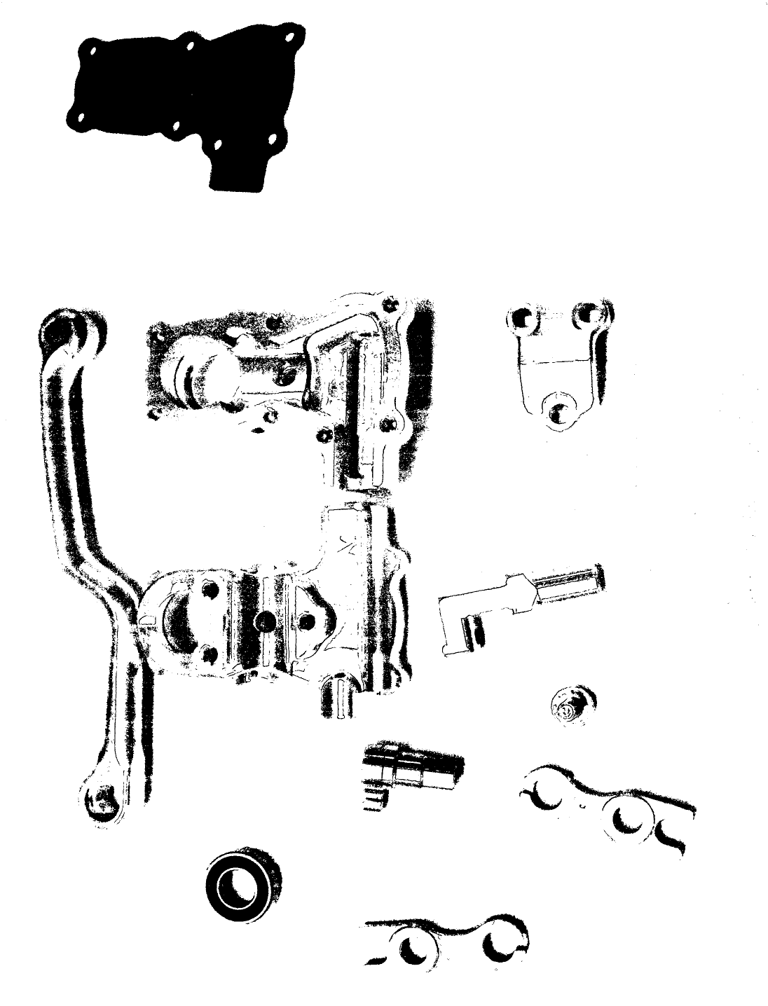

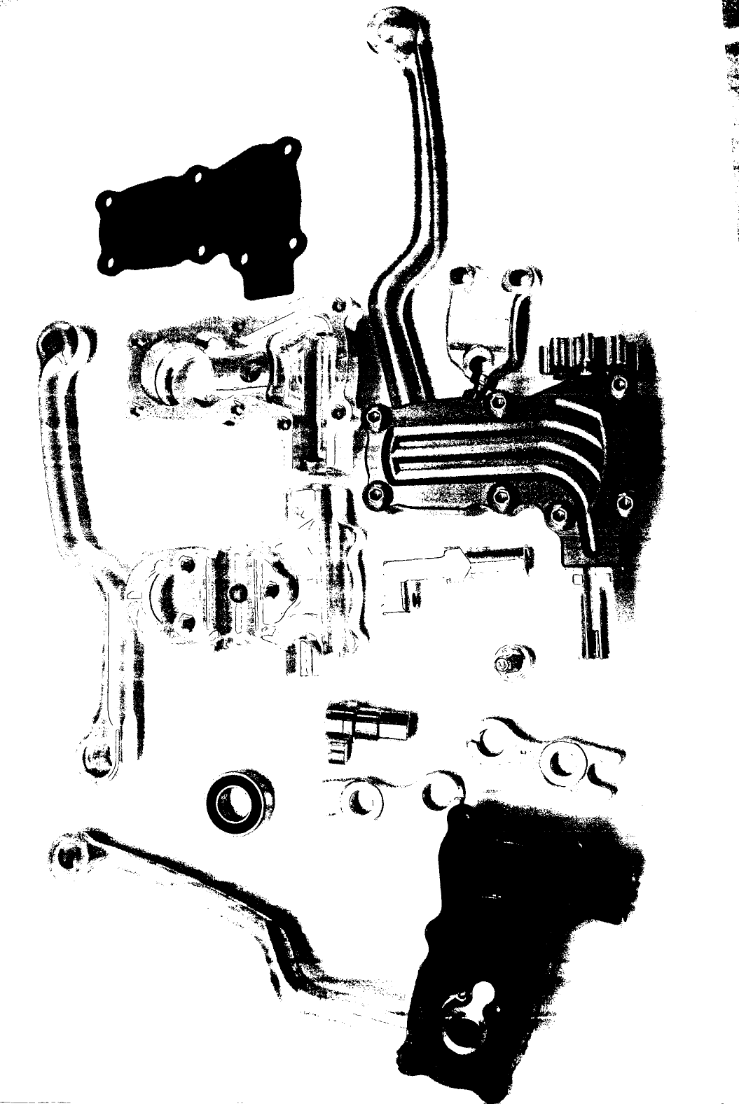

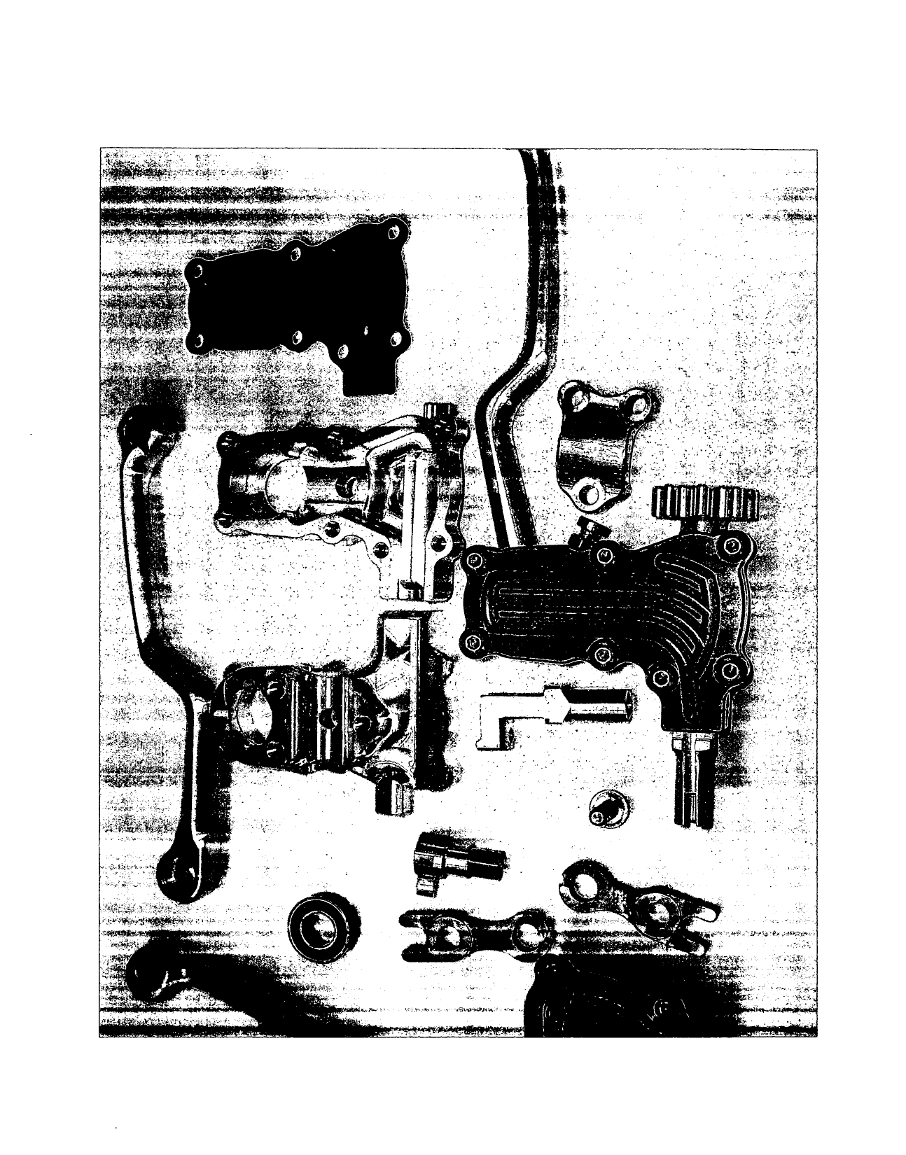

FIG. 4 is a perspective taken from the bottom of the clutch control constructed in accordance with the invention. This picture depicts the unit fully assembled. Showing its housing cover in place and secured by 7 screws. It also shows part #10 the cable backlash adjuster, and shows part #12 the cable backlash slider in their respective places.

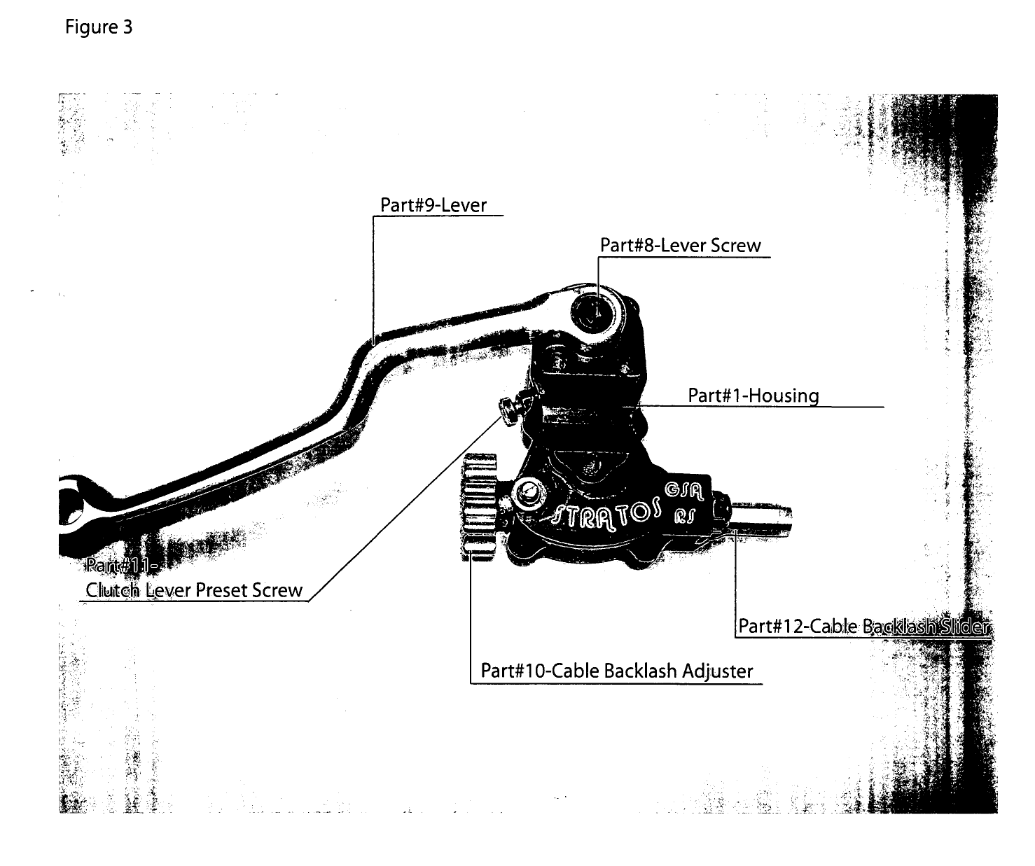

In FIG. 3, we see the cable backlash adjuster. This adjusting screw is secured by spring loaded ball fit into slots. Making this adjuster a “clicker” so that it maintains the user's setting, and allows for precise adjustments.

Operation

In operation the user will use the clutch lever in his/her motorcycle/atv in the usual fashion, on the left hand side of the handlebar. The housing will sit on the handlebar with the cable adjuster screw located on the inside of the handle bar facing the rider next to the left grip (within thumbs' reach). Clutch cable will come under the handlebar and into the housing on the inside of the handlebar (between rider and handlebar). When clutch lever is pulled the lever actuator will move from side to side in accordance with the lever. Thus, moving the cable link which will as result either pull or release the clutch cable that is coming into the housing from the motor vehicle. The clutch lever will be located in the same position that clutch levers are located today. Due to its uniqueness this device will improve upon many current problems that exist today.

Some of the Problems that Exist Today with Motorcycle Clutches are:

1 . Currently the clutch cable is in front of handlebars, and left susceptible to being damaged in case of impact.

2. Currently the clutch cable is left exposed when clutch lever is pulled, allowing for dirt, debris, and rocks to enter the pull mechanism while riding.

3. Currently the “freeplay” on the clutch cable will change while riding, especially if racing, due to wear and dirt getting into the clutch lever pull mechanism.

4. Currently riders must use both hands to adjust “freeplay” on the clutch cable. Meaning a rider cannot adjust play while riding.

5. If rider falls, the clutch lever, its pull mechanism, or clutch cable are very susceptible to breakage or severe damage because it's mechanics are exposed.

6. If clutch lever breaks while racing rider is considered to be out because of the amount of time it takes to replace it with a new one.

This Invention Will Improve on These Problems by the Following Means:

1. The clutch cable comes into the housing from underneath the handlebars and is placed between the rider and the handlebars; as a result this significantly improves protection for the clutch cable and the entire clutch mechanism in case of fall.

2. The housing will be completely sealed, thus preventing any dirt, debris, or rocks from damaging the clutch cable pull mechanism.

3. Because this mechanism will be enclosed in a sealed environment and operated in a clean environment with the use of lubrication the “freeplay” on the cable will be maintained for significantly longer.

4. Cable adjuster screw is located within thumbs' reach for extremely easy “freeplay” adjusting while riding. Allowing for adjusting while riding, saving many riders time and for long races allowing the riders to adjust the play to their desire instantly on the fly.

5. The mechanism is enclosed in 7075 aluminum, so if rider falls the clutch pull mechanism is no longer as susceptible to being damaged. Since the clutch cable is also coming into the sealed box, the cable is significantly less likely to become damaged.

6. This product allows for an extremely more efficient way of replacing the clutch lever which is the only part that is susceptible to breaking. Through the use of the screw that connects to the lever actuator, the user will be able to change clutch levers in less than 10 seconds by removing a single screw. No longer costing a rider a race.

7. The clutch lever will be able to be adjusted to accommodate different hand sizes, allowing for a more comfortable use by different size riders. The distance between the lever and the handlebar grip and be either increased for longer fingers or decreased for shorter fingers.

8. Cable Adjuster screw will be secured by spring loaded ball fit into slots. This mechanism allows holding the adjuster screw in position. Making it a “clicker”. 9. There are two different lengths for cable actuator, one which is stock “feel” and one which is for “easy pull”

1. I hereby claim the invention to be much more reliable and resistant than any other clutch available. This clutch is and will always be built using only 7075 aluminum which will always make it super tough, and resistant to wear and tear. This clutch system will allow its users to adjust free play while riding, without having to stop as it is currently done. It will provide its users with more flexibility and ease of use. It will provide a clear advantage over what is available in the market today.
